(19) United States
(12) Patent Application Publication
(10) Pub. No.: US 2025/0286112 A1
(43) Pub. Date: Sep. 11, 2025

(54) METHOD FOR ASSEMBLING BATTERY MODULE AND HOLDING MECHANISM

(71) Applicant: HONDA MOTOR CO., LTD., Tokyo (JP)

(72) Inventors: Wataru Ohira, Wako-shi (JP); Yuya Ishihara, Wako-shi (JP)

(21) Appl. No.: 19/069,390

(22) Filed: Mar. 4, 2025

(30) Foreign Application Priority Data
Mar. 7, 2024 (JP) 2024-034518

(51) Int. Cl. H01M 10/04; H01M 10/613; H01M 10/6555; H01M 10/6556; H01M 10/6568

(52) U.S. Cl. CPC H01M 10/0481; H01M 10/6555; H01M 10/613; H01M 10/6556; H01M 10/6568

(57) ABSTRACT

A battery module assembling method includes a region forming step of forming a region where a cell stack is placeable between a pair of holding plates by applying a coercive deformation force that deforms at least one of the pair of holding plates against an elastic biasing force, a arranging step of arranging the cell stack in the region formed in the region forming step, and a pressing step of pressing the cell stack in the stacking direction by the elastic biasing force, by removing the coercive deformation force in a state where the cell stack is placed in the region.

### CROSS-REFERENCE TO RELATED APPLICATIONS

This application is based upon and claims the benefit of priority from Japanese Patent Application No. 2024-034518 filed on Mar. 7, 2024, the contents of which are incorporated herein by reference.

### BACKGROUND OF THE INVENTION

### Field of the Invention

The present disclosure relates to a method for assembling a battery module and a holding mechanism.

### Description of the Related Art

JP 2023-101130 A discloses a battery module including a cell stack formed by stacking battery cells and heat exchangers. The battery module further includes a battery frame as a holding mechanism that holds the cell stack by applying a tightening load from both sides of the cell stack. The battery frame prevents movement of the battery cells and the heat exchangers.

The battery frame has a pair of spring plates and four rod-like connecting members for connecting the pair of spring plates with each other. The spring plate has four arm portions that project radially from a central portion. When the cell stack is assembled to the battery frame, the screw structures (bolts and nuts) provided at both ends of the connecting member are tightened, whereby a tightening force is applied to the cell stack to hold the cell stack.

### SUMMARY OF THE INVENTION

In the case of JP 2023-101130 A, since a pair of holding plates are fixed to the connecting members by means of a plurality of screw structures, respectively, it is difficult to equalize the distance between the nuts at both ends of the connecting member among the plurality of connecting members. Therefore, it is difficult to apply the stress evenly to the plurality of connecting members.

The present disclosure aims to solve the aforementioned problems.

A first aspect of the present disclosure is a method for assembling a battery module, which includes: a cell stack that includes battery cells and heat exchangers stacked on the battery cells; and a holding mechanism that holds both ends in a stacking direction of the cell stack, the holding mechanism includes a pair of holding plates that are elastically deformable, and a plurality of connecting members that connect the pair of holding plates with each other, and the cell stack is pressed inward in the stacking direction by the elastic biasing force of the pair of holding plates, whereby the cell stack is held, the method including: a region forming step of forming a region where the cell stack is configured to be placed between the pair of holding plates by applying coercive deformation force that deforms at least one of the pair of holding plates against the elastic biasing force; an arranging step of arranging the cell stack in the region formed in the region forming step, and a pressing step of pressing the cell stack in the stacking direction by the elastic biasing force, by removing the coercive deformation force in a state where the cell stack is placed in the region.

A second aspect of the present disclosure is a holding mechanism including a pair of holding plates that are elastically deformable and face each other, and a plurality of connecting members that connect the pair of holding plates with each other, wherein the holding mechanism is configured to hold a holding object placed between the pair of holding plates by the elastic biasing force of the pair of holding plates, each of the plurality of holding plates includes a pressing portion, and a plurality of arm portions extending from the pressing portion toward the plurality of connecting members, the plurality of arm portions are connected to the plurality of connecting members, and the pressing portion is configured to be moved in a direction to increase a space between the pair of holding plates by external force from the outside of the pair of holding plates.

According to the present disclosure, by externally applying a coercive deformation force to the holding plate, it is possible to form a region where the cell stack can be placed. In addition, by removing the coercive deformation force, it is possible to hold the cell stack by the elastic biasing force of the holding plate. Thus, the holding plate does not need to be tightened by the screw structure, and the holding plate and the connecting member can be fixed in such a way that positions are not adjustable. Therefore, the stress is applied evenly to the plurality of connecting members. As a result, the tightening force can be properly applied to the cell stack.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a battery module;

FIG. 2 is an exploded perspective view of a cell stack;

FIG. 3 is a schematic cross-sectional view taken along a line III-III of FIG. 1;

FIG. 4A is an explanatory diagram of a preparatory step of a region forming step in a method for assembling a battery module according to the first embodiment; FIG. 4B is an explanatory diagram of a moving step of the region forming step;

FIG. 5A is an explanatory diagram of a placement process;

FIG. 5B is an explanatory diagram of a pressing step;

FIG. 6 is a perspective view of an engaging structure;

FIG. 7A is an explanatory diagram of an engaging step of a region forming step in a method for assembling a battery module according to the second embodiment; FIG. 7B is an explanatory diagram of a moving step of the region forming step;

FIG. 8A is an explanatory diagram of a preparatory step of a region forming step in a method for assembling a battery module according to the third embodiment; FIG. 8B is an explanatory diagram of a moving step of the region forming step; and

FIG. 9 is a schematic diagram of an aircraft in which the battery module is mounted.

### DETAILED DESCRIPTION OF THE INVENTION

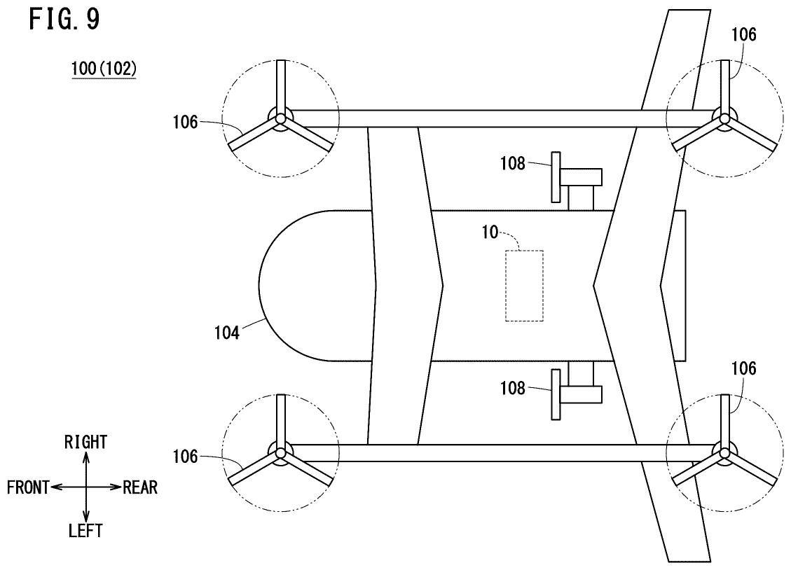

As shown in FIG. 9, a battery module 10 is mounted in, for example, an aircraft 102 as a mobile object 100. The aircraft 102 is, for example, an electric vertical take-off and landing aircraft (eVTOL). The aircraft 102 includes a fuselage 104, multiple (e.g., four) VTOL rotors 106, and multiple (e.g., two) cruise rotors 108.

The VTOL rotor 106 generates an upward thrust force with respect to the aircraft 102. The cruise rotor 108 generates a horizontal thrust force with respect to the aircraft 102. The battery module 10 is placed inside the fuselage 104. The battery module 10 supplies power to an electric motor (not shown) that drives each of the VTOL rotors 106 and the cruise rotors 108. The mobile object 100 may also be, for example, a vehicle, a ship, or the like. The battery module 10 is not limited to the example where the battery module 10 is mounted in the mobile object 100.

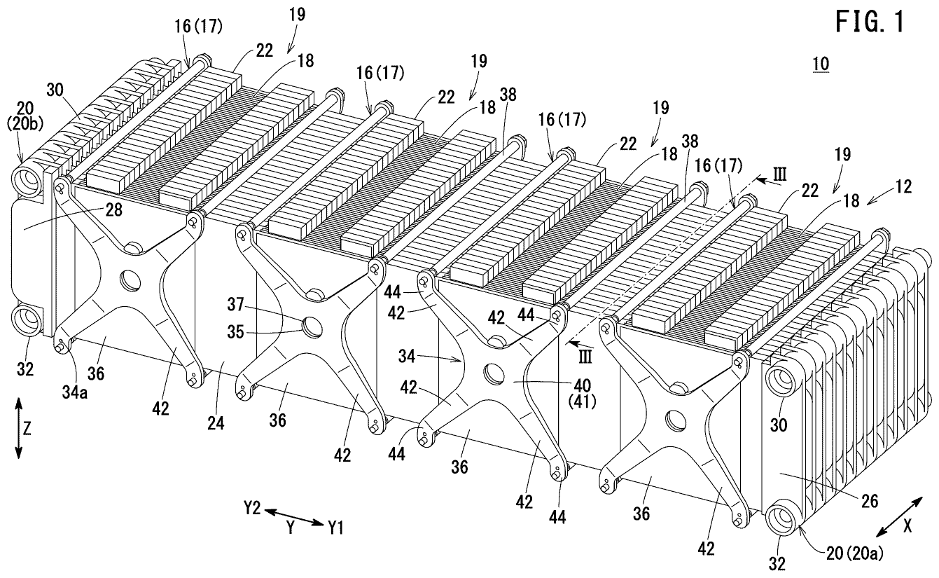

As shown in FIG. 1, the battery module 10 includes a cell stack 12 and a plurality of battery frames 16.

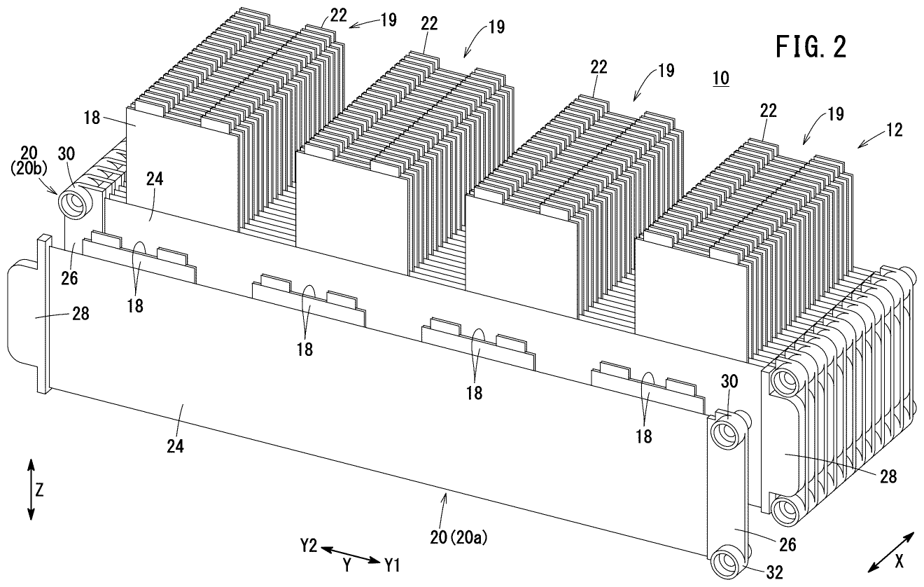

As shown in FIG. 2, the cell stack 12 includes a plurality of battery cells 18 and a plurality of heat exchangers 20. A single cell row 19 is formed of a plurality of battery cells 18 arranged in the direction of the arrow X. In this embodiment, four cell rows 19 are arranged in the direction of the arrow Y. The number of cell rows 19 may be three or less, or four or more. Only one cell row 19 may be provided in the battery module 10.

The battery cells 18 and the heat exchangers 20 are arranged (stacked) in the direction of the arrow X. In the following, the X direction is also referred to as the “stacking direction”. In addition, the direction toward the center of the battery module 10 in the X direction is expressed as “inward in the stacking direction”. The direction away from the center of the battery module 10 in the X direction is expressed as “outward in the stacking direction”.

The battery cell 18 is a laminate type battery. The battery cell 18 is formed in a rectangular plate shape. A plurality of terminal portions 22 project from one side of the battery cell 18 in the direction of the arrow Z. The battery cells 18 are connected in series with each other via the terminal portions 22. The terminal portions 22 are conceptually illustrated. Electrical connecting members (not shown) are bonded to the terminal portions 22.

The heat exchangers 20 include a plurality of first heat exchangers 20a and a plurality of second heat exchangers 20b. As shown in FIG. 2, each first heat exchanger 20a has a plate-like water jacket 24, a water supply-drainage header 26, and a turn header 28. The water jacket 24 extends in the direction of the arrow Y. A flow path through which cooling water circulates is formed in the water jacket 24. Although not shown in detail, this flow path has a forward flow path for letting cooling water flow from the water supply-drainage header 26 toward the turn header 28 and a return flow path for letting cooling water flow from the turn header 28 toward the water supply-drainage header 26.

The water supply-drainage header 26 is provided at one end (Y1 direction side) in the longitudinal direction (direction of the arrow Y) of the water jacket 24. The water supply-drainage header 26 supplies cooling water to and discharges cooling water from the water jacket 24.

The water supply-drainage header 26 has a water supply port 30 and a water drainage port 32. The water supply port 30 supplies cooling water to the forward flow path of the water jacket 24. The water supply ports 30 of the first heat exchangers 20a adjacent to each other are connected liquid-tightly to each other. The drainage port 32 discharges the cooling water from the return flow path of the water jacket 24. The drainage ports 32 of the first heat exchangers 20a adjacent to each other are connected liquid-tightly to each other.

Although the details are not illustrated, the water supply ports 30 of the first heat exchangers 20a adjacent to each other are connected to be relatively movable in the X direction so that the expansion of the battery cells 18 in the X direction caused by heat generation or deterioration of the battery cells 18 can be absorbed. Similarly, the drainage ports 32 of the first heat exchangers 20a adjacent to each other are connected to each other to be relatively movable in the X direction.

The turn header 28 is provided at the other end (Y2 direction side) of the water jacket 24 in the longitudinal direction. The turn header 28 receives cooling water from the forward flow path of the water jacket 24 and lets the cooling water flow to the return flow path of the water jacket 24.

The second heat exchanger 20b has a water jacket 24, a water supply-drainage header 26, and a turn header 28, as the first heat exchanger 20a. However, the second heat exchanger 20b is arranged in a different direction from the first heat exchanger 20a in the Y-direction. Therefore, in the case of the second heat exchanger 20b, the water supply-drainage header 26 is arranged on the Y2 direction side of the water jacket 24, and the turn header 28 is arranged on the Y1 direction side of the water jacket 24.

The first heat exchanger 20a and the second heat exchanger 20b are alternately arranged in the direction of the arrow X. Thus, the water supply-drainage header 26 of one of the first heat exchanger 20a and the second heat exchanger 20b and the turn header 28 of the other of the first heat exchanger 20a and the second heat exchanger 20b are adjacent to each other in the stacking direction (X direction).

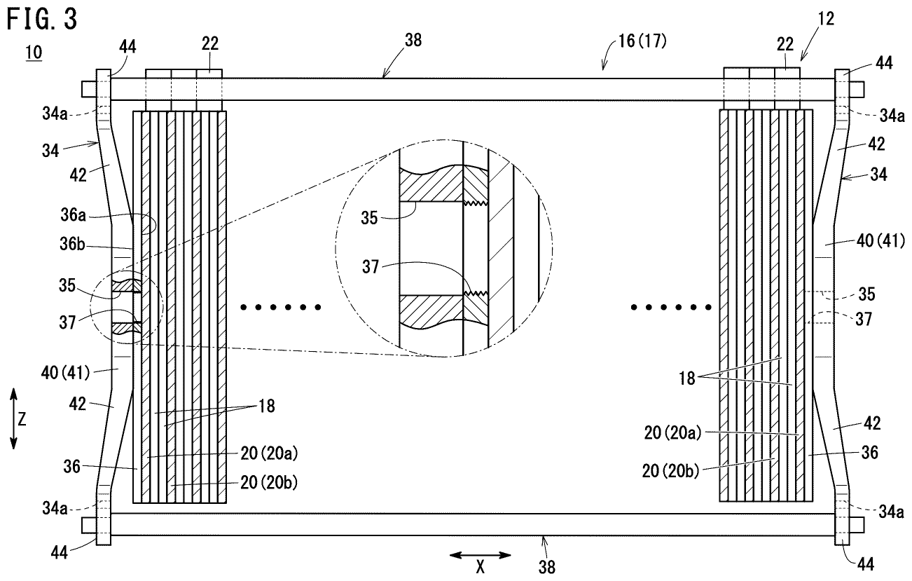

As shown in FIG. 3, two battery cells 18 are stacked in the direction of the arrow X between the first heat exchanger 20a and the second heat exchanger 20b that are adjacent to each other.

As shown in FIG. 1, in this embodiment, four battery frames 16 are provided corresponding to the four cell rows 19. The number of battery frames 16 may be three or less or five or more depending on the number of cell rows 19.

As shown in FIGS. 1 and 3, the battery frame 16 includes a pair of holding plates 34, a pair of pressure receiving plates 36, and a plurality of connecting members 38. The pair of holding plates 34 are placed at the end portions of the battery module 10 in the direction of the arrow X. The battery frame 16 is a holding mechanism 17 that can hold, by the elastic biasing force of the pair of holding plates 34, a holding object (cell stack 12) placed between the pair of holding plates 34.

The pair of holding plates 34 are located outward in the stacking direction of the battery cells 18. The holding plate 34 is made of, for example, titanium alloy. The holding plate 34 may be made of a metal material other than titanium alloy.

As shown in FIG. 1, the holding plate 34 is formed in an X-shape when viewed from the thickness direction (the direction of the arrow X) of the holding plate 34. The holding plate 34 has a point-symmetric shape. The holding plate 34 includes a plate central portion 40 and a plurality of arm portions 42.

The plate central portion 40 is a pressing portion 41 that presses the cell stack 12 in the stacking direction via the pressure receiving plate 36. The plate central portion 40 is placed at a central portion of the holding plate 34. The plate central portion 40 is located more inward in the stacking direction than an arm tip portion 44, which is an end portion in the extending direction of the arm portion 42. Therefore, when viewed from the direction perpendicular to the stacking direction, the holding plate 34 as a whole has a shape that is convex inward in the stacking direction. The plate central portion 40 is formed with a through hole 35. The through hole 35 is formed at a central portion of the holding plate 34. The through hole 35 is circular when viewed from the X direction. The function of the through hole 35 will be described later.

The arm portions 42 extend radially from the plate central portion 40. The arm portions 42 are provided at equal intervals in the circumferential direction of the plate central portion 40. The arm portion 42 is a leaf spring portion that is elastically deformed when a tightening load is applied to the cell stack 12. In this embodiment, the holding plate 34 has four arm portions 42. The number of arm portions 42 of the holding plate 34 may be three or less or five or more.

At one of the holding plates 34, the arm tip portion 44 that is an end portion in the extending direction of the arm portion 42 is connected to one end portion of the connecting member 38 by, for example, welding or the like. At the other of the holding plates 34, the arm tip portion 44 that is an end portion in the extending direction of the arm portion 42 is connected to the other end portion of the connecting member 38 by, for example, welding or the like. In other words, at the pair of holding plates 34, the arm tip portions 44 are fixed (stuck) to the opposite ends of the connecting member 38 in such a way that positions thereof are not adjustable.

The arm tip portion 44 is located more outward than the cell stack 12 when viewed from the stacking direction (the direction of the arrow X) of the battery cells 18. The arm tip portion 44 does not overlap with the terminal portions 22 when viewed from the direction of the arrow X. The arm tip portion 44 is provided with a positioning hole 34a. The function of the positioning holes 34a will be described later.

The elastic force (spring force) of the four arm portions 42 is applied to the cell stack 12 as the tightening load via the pressure receiving plate 36. This tightening load is the holding force of the holding plate 34 with respect to the cell stack 12. The battery frame 16 holds the cell stack 12 solely by the frictional force generated by the force of the holding plate 34 pushing the cell stack 12 via the pressure receiving plate 36.

The pressure receiving plate 36 is a pressing plate for evenly applying to the cell stack 12 the tightening load applied from the holding plate 34. The pressure receiving plate 36 is placed between the holding plate 34 and the cell stack 12. The pressure receiving plate 36 is formed in a square shape. The pressure receiving plate 36 is not essential. Therefore, the cell stack 12 may be directly pressed by the plate central portion 40 without the pressure receiving plate 36 being provided.

As shown in FIG. 3, the pressure receiving plate 36 is formed with a threaded portion 37. The function of the threaded portion 37 will be described later. Specifically, the threaded portion 37 is an internal thread. In this embodiment, the threaded portion 37 penetrates the pressure receiving plate 36. The threaded portion 37 does not have to penetrate the pressure receiving plate 36. The diameter of the threaded portion 37 is approximately the same as the diameter of the through hole 35 formed at the plate central portion 40 of the holding plate 34. Specifically, the diameter of the threaded portion 37 is slightly smaller than the diameter of the through hole 35. That is, the diameter of the through hole 35 is slightly larger than the diameter of the threaded portion 37.

A first surface 36a of the pressure receiving plate 36 facing the cell stack 12 is in surface contact with an end surface of the cell stack 12. A second surface 36b of the pressure receiving plate 36 facing in the direction opposite to the cell stack 12 is in surface contact with the plate center portion 40 of the holding plate 34. The battery frame 16 may omit the pressure receiving plate 36.

As shown in FIG. 1, with the holding plate 34 being attached to the pressure receiving plate 36, the four arm portions 42 extend, overlapping respectively with four corner portions of the pressure receiving plate 36 when viewed in the direction of the arrow X. With the holding plate 34 being attached to the pressure receiving plate 36, a gap is provided between the arm portion 42 and the corner portions of the pressure receiving plate 36. With the holding plate 34 being attached to the pressure receiving plate 36, the four arm tip portions 44 are located more outward than the pressure receiving plate 36 when viewed in the direction of the arrow X.

The plurality of connecting members 38 connect the pair of holding plates 34 to each other in such a way that the tightening load (compressive load) is applied from the pair of holding plates 34 to the cell stack 12. In this embodiment, the battery frame 16 has four connecting members 38. Each connecting member 38 is a shaft that extends along the stacking direction of the battery cells 18. The connecting member 38 is made of, for example, a metallic material, such as stainless steel.

The battery frame 16 configured as described above can move the pressing portion 41 in the direction to widen a space between the pair of holding plates 34 by the external force from the outside of the pair of holding plates 34.

Next, a method of assembling the battery module 10 according to the first embodiment will be described.

The method of assembling the battery module 10 according to the first embodiment includes a region forming step, a placing step, and a pressing step.

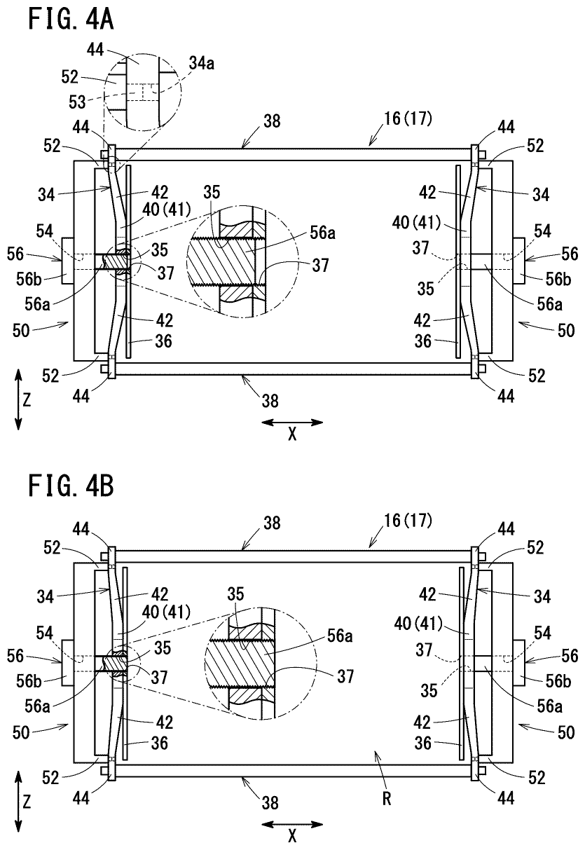

As shown in FIGS. 4A and 4B, in the region forming step, a region R in which the cell stack 12 can be placed is formed between the pair of holding plates 34 by applying a coercive deformation force that deforms at least one of the pair of holding plates 34 against the elastic biasing force of the holding plates 34. Although the case where both of the pair of holding plates 34 are deformed will be described here, only one of the holding plates 34 may be deformed.

The region forming step includes a preparatory step and a moving step. In the preparatory step, first, as shown in FIG. 4A, an auxiliary jig 50 for coercive deformation is attached to the outside of the holding plate 34. The auxiliary jig 50 has a leg portion 52 that is in contact with the arm tip portion 44 of the holding plate 34. The leg portion 52 is provided with a positioning projection 53. The positioning projection 53 is inserted into the positioning hole 34a provided at the holding plate 34, whereby the auxiliary jig 50 is positioned with respect to the holding plate 34. It is noted that the positioning holes 34a may be provided at the auxiliary jig 50 whereas the positioning projection 53 may be provided at the holding plate 34.

In the preparatory step, the shaft portion 56a (external thread) of the bolt 56 is inserted into the hole portion 54 provided at a central portion of the auxiliary jig 50. The bolt 56 is one aspect of a structural member for moving the plate center portion 40 in a direction to increase the space between the pair of holding plates 34. The hole portion 54 is a hole in which no thread is formed. Thus, the shaft portion 56a of the bolt 56 cannot be screwed into the hole portion 54. The shaft portion 56a of the bolt 56 penetrates the auxiliary jig 50 and is inserted into the through hole 35 provided in the holding plate 34. At this time, the tip of the shaft portion 56a of the bolt 56 is slightly engaged with (screwed into) the threaded portion 37 provided at the pressure receiving plate 36. Also, the head 56b of the bolt 56 is brought into contact with the auxiliary jig 50.

As shown in FIG. 4B, in the moving step of the region forming step, the bolt 56 is rotated while an axial position of the bolt 56 is fixed, whereby the plate central portion 40 is moved in the direction (outward in the X direction) in which the plate central portion 40 is brought closer to the auxiliary jig 50. Specifically, when the bolt 56 inserted into the auxiliary jig 50 is rotated, the plate central portion 40 is displaced forcibly toward the auxiliary jig 50 against the elastic biasing force of the holding plate 34 by the screwing action between the shaft portion 56a of the bolt 56 and the threaded portion 37 of the pressure receiving plate 36. The plate center portion 40 of each of the pair of holding plates 34 is displaced toward the auxiliary jig 50, whereby a region R is formed in which the cell stack 12 can be placed between the pair of holding plates 34 (between the pair of pressure receiving plates 36 in the first embodiment).

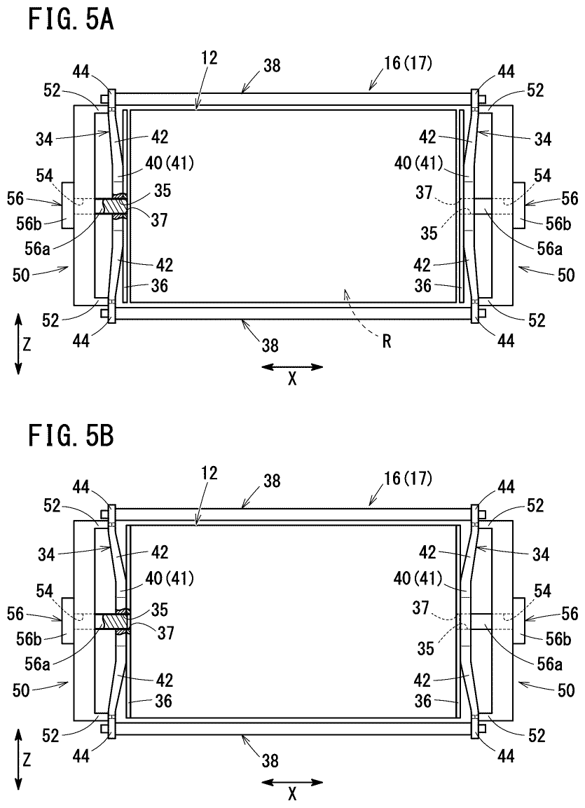

Next, as shown in FIG. 5A, in the placement step, the cell stack 12 is placed in the region R formed by the region formation step. It is preferable that the assembly method including the placement step is performed in such a way that the X direction is the vertical direction. In this way, the cell stack 12 can be placed on one of the pressure receiving plates 36 and thus the cell stack 12 can be easily placed in the region R formed by the region forming step. In FIGS. 5A and 5B, the cell stack 12 is shown in a simplified manner.

Next, as shown in FIG. 5B, in the pressing step, in a state where the cell stack 12 is arranged in the region R, the above-described coercive deformation force is removed, whereby the cell stack 12 is pressed in the stacking direction by the elastic biasing force of the holding plate 34 by. Specifically, the bolt 56 is rotated in the direction opposite to the rotation direction of the bolt 56 in the region forming step and the bolt 56 is loosened, whereby the holding plate 34 and the pressure receiving plate 36 are displaced toward the cell stack 12. Thereby, a tightening load is applied to the cell stack 12 by the pair of holding plates 34.

The first embodiment provides the following benefits.

As shown in FIG. 5A, by applying a coercive deformation force from the outside to the holding plate 34, it is possible to form the region R in which the cell stack 12 can be placed. In addition, as shown in FIG. 5B, by removing the coercive deformation force, it is possible to hold the cell stack 12 by the elastic biasing force of the holding plate 34. This eliminates the need to tighten the holding plate 34 to the connecting member 38 by means of the screw structure, and the holding plate 34 and the connecting member 38 can be fixed in such a way that positions are not adjustable. Therefore, the stress is applied evenly to the plurality of connecting members 38. As a result, the tightening force can be properly applied to the cell stack 12.

As shown in FIG. 4B, in the region forming step, a coercive deformation force is applied in a state where the end portion (arm tip portion 44) in the extending direction of the arm portion 42 is fixed, whereby the arm portion 42 is deformed. This allows the arm portion 42 to be effectively deformed.

In the area forming step, the plate central portion 40 (pressing portion 41) is moved in the direction opposite to the pressing direction in which the cell stack 12 is pressed in the pressing step. This makes it possible to properly form the region R in which the cell stack 12 can be placed.

In the region forming step, the bolt 56 is screwed into the thread portion 37 formed at the pressure receiving plate 36, and the bolt 56 is rotated while the axial position of the bolt 56 is fixed, whereby the plate central portion 40 is moved. As a result, the plate central portion 40 can be moved effectively. The threaded portion 37 may be formed at the plate central portion 40. In this case, in the region forming step, the bolt 56 is screwed into the threaded portion 37 formed at the plate central portion 40, and the bolt 56 is rotated while the axial position of the bolt 56 is fixed, whereby the plate central portion 40 is moved. Alternatively, the threaded portion 37 may be formed at both the pressure receiving plate 36 and the plate center portion 40.

In the region forming step, the bolt 56 inserted through the auxiliary jigs 50 attached to the holding plate 34 are rotated. This allows the plate center portion 40 of the holding plate 34 to be easily moved as the bolt 56 rotates.

Next, a method of assembling the battery module 10 according to the second embodiment will be described.

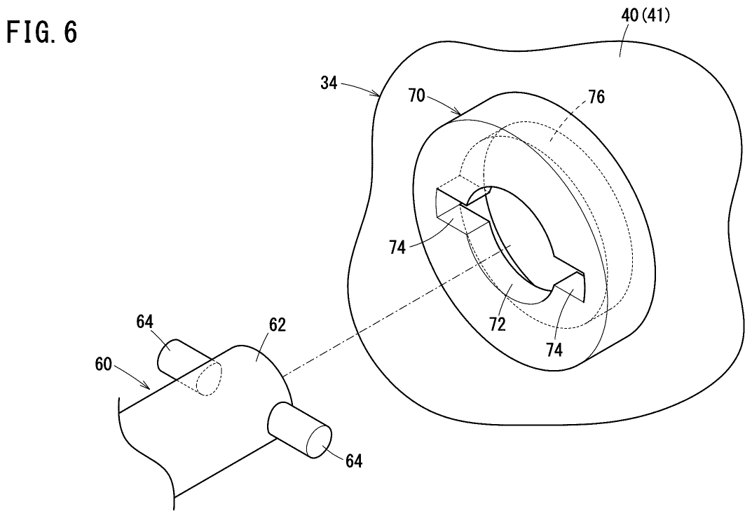

As shown in FIG. 6, an engaging structure 70 that can engage with the displacement jig 60 is provided at the plate center portion 40 of the holding plate 34. The engaging structure 70 has a central hole 72, a slit 74, and an engaging groove 76. The slit 74 can receive the tip portion 62 of the displacement jig 60. In FIG. 6, a pair of slits 74 are formed extending from the central hole 72 in opposite directions. The engaging groove 76 can be engaged with the tip portion 62 of the displacement jig 60 inserted via the slit 74. The engaging groove 76 communicates with the slit 74.

The displacement jig 60 is one aspect of a structural member for moving the plate center portion 40 in a direction to increase the space between the pair of holding plates 34. A pair of engaging pins 64 are provided at the tip portion 62 of the displacement jig 60. The pair of engaging pins 64 are insertable into the pair of slits 74 of the engaging structure 70. The pair of engaging pins 64 can be engaged with the engaging grooves 76 of the engaging structure 70. A single engaging pin 64 and a single slit 74 may be provided. Three or more engaging pins 64 and three or more slits 74 may be provided.

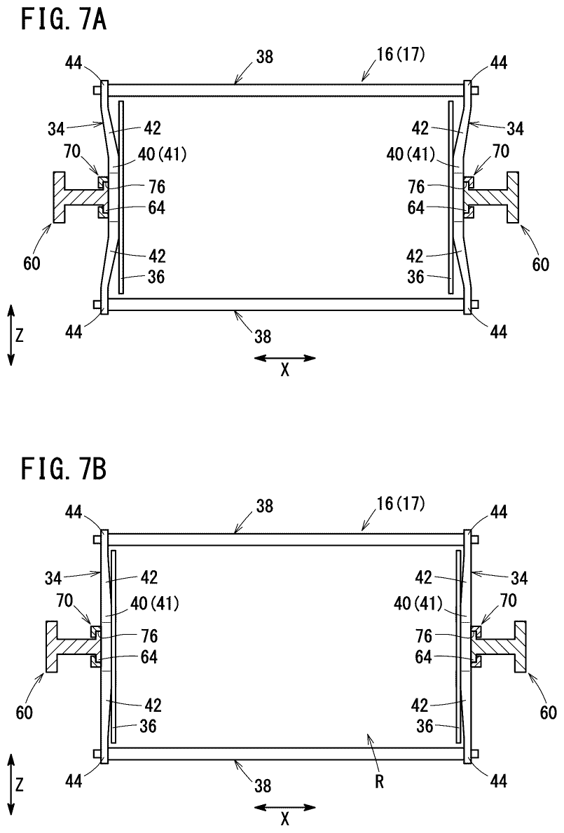

In the method of assembling the battery module 10 according to the second embodiment, the region forming step includes an inserting step, an engaging step, and a moving step. In the inserting step, the tip portion 62 (the pair of engaging pins 64) of the displacement jig 60 is inserted into the pair of slits 74 of the engaging structure 70. Next, as shown in FIG. 7A, in the engaging step, the displacement jig 60 is rotated, whereby the engaging pins 64 of the displacement jig 60 are engaged with the engaging grooves 76 of the engaging structure 70.

Next, as shown in FIG. 7B, in the moving step, the displacement jig 60 is pulled, whereby the holding plate 34 is forcibly displaced and the plate center portion 40 is moved to the outward direction of the battery frame 16 (outward in the X direction). Thus, a region R in which the cell stack 12 can be placed is formed between the pair of holding plates 34 (between the pair of pressure receiving plates 36 in the second embodiment).

Although not shown, the placing step and the pressing step are performed subsequently in the same manner as in the first embodiment. Specifically, in the second embodiment, the cell stack 12 is placed in the formed region R. Thereafter, the pulling force on the displacement jig 60 is released, whereby the coercive deformation force on the holding plate 34 is removed and the holding plate 34 and the pressure receiving plate 36 are displaced toward the cell stack 12. Thereby, a tightening load is applied to the cell stack 12 by the pair of holding plates 34.

The second embodiment also can properly apply the tightening force to the cell stack 12. In the second embodiment, the displacement jig 60 is engaged with the engaging structure 70 and further the displacement jig 60 is pulled, whereby the holding plate 34 is deformed forcibly. Therefore, the region R where the cell stack 12 can be placed between the pair of holding plates 34 can be formed by a simple method. The engaging structure 70 may be provided on the pressure receiving plate 36. In this case, the plate central portion 40 is provided with an insertion hole through which the displacement jig 60 is inserted.

Next, a method of assembling the battery module 10 according to the third embodiment will be described.

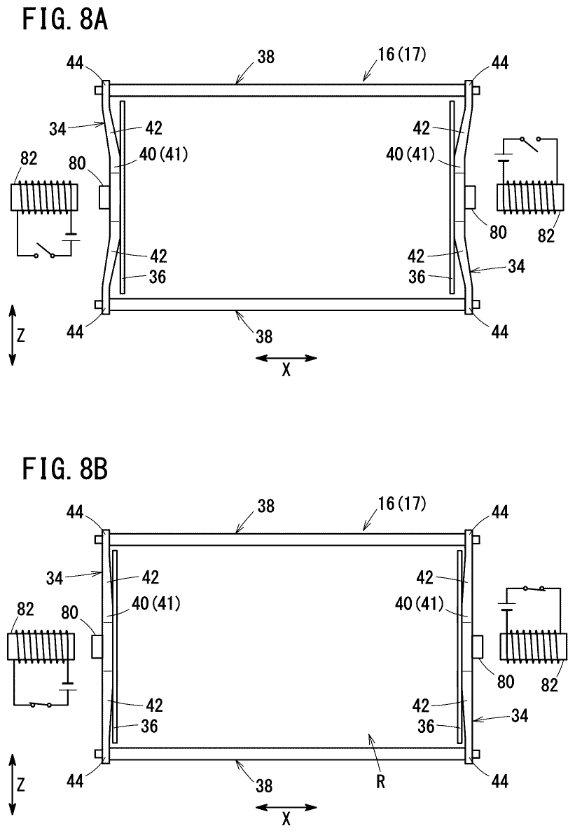

As shown in FIG. 8A, a permanent magnet 80 is fixed to the plate center portion 40 of each of the pair of holding plates 34. The region forming step in the assembling method according to the third embodiment includes a preparatory step and a moving step. In the preparatory step, a pair of electromagnets 82 are placed outside the battery frame 16 so as to face, with a space, the permanent magnets 80 fixed to the pair of holding plates 34.

Next, as shown in FIG. 8B, in the moving step, the plate central portion 40 is moved by external magnetic force. Specifically, the pair of electromagnets 82 are energized, whereby the permanent magnets 80 are pulled toward the electromagnets 82 by magnetic force. Thus, the plate central portion 40 is moved toward the outside of the battery frame 16 (outward in the X direction). Thus, a region R in which the cell stack 12 can be placed is formed between the pair of holding plates 34 (between the pair of pressure receiving plates 36 in the third embodiment).

Although not shown, the placing and pressing steps are then performed in the third embodiment as in the first embodiment. Specifically, in the third embodiment, the cell stack 12 is placed in the formed region R. Thereafter, energizing of the pair of electromagnets 82 is stopped, whereby the coercive deformation force on the holding plate 34 is removed and the holding plate 34 and the pressure receiving plate 36 are displaced toward the cell stack 12. Thereby, a tightening load is applied to the cell stack 12 by the pair of holding plates 34.

The third embodiment also can properly apply the clamping force to the cell stack 12. In the third embodiment, the plate central portion 40 is moved by external magnetic force. Therefore, the region R where the cell stack 12 can be placed between the pair of holding plates 34 can be formed by a simple method. The plate central portion 40 may be configured in such a way that the permanent magnet 80 is attachable and detachable. When the plate central portion 40 is made of a metal material (ferromagnetic material) that can be attracted by the magnetic force of the permanent magnet 80, the permanent magnet 80 may be omitted.

With respect to the above embodiments, we further disclose the following supplementary note.

### (Supplementary Note 1)

Concerning a method for assembling a battery module (10) of the present disclosure, the battery module includes: a cell stack (12) that includes battery cells (18) and heat exchangers (20) stacked on the battery cells; and a holding mechanism (17) that holds both ends in the stacking direction of the cell stack, the holding mechanism includes a pair of holding plates (34) that are elastically deformable, and a plurality of connecting members (38) that connect the pair of holding plates with each other, and the cell stack is pressed inward in the stacking direction by the elastic biasing force of the pair of holding plates, whereby the cell stack is held. The method includes a region forming step of forming a region (R) where the cell stack is placeable between the pair of holding plates by applying a coercive deformation force that deforms at least one of the pair of holding plates against the elastic biasing force, a placement step of placing the cell stack in the region formed in the region forming step, and a pressing step of pressing the cell stack in the stacking direction by the elastic biasing force, by removing the coercive deformation force in a state where the cell stack is placed in the region.

### (Supplementary Note 2)

In the method described in Supplementary note 1, each of the pair of holding plates may include a pressing portion (41) and an arm portion (42) that extends from the pressing portion, and in the region forming step, the arm portion may be deformed by applying the coercive deformation force in a state where an end portion in an extending direction of the arm portion fixed.

### (Supplementary Note 3)

In the method according to Supplementary note 2, in the region forming step, the pressing portion may be moved in a direction opposite to the pressing direction in which the cell stack is pressed in the pressing step.

### (Supplementary Note 4)

In the method described in Supplementary note 3, at least one of the pressing portion and the pressure receiving plate (36) superposed on the pressing portion may be provided with a threaded portion (37), and in the region forming step, the pressing portion may be moved by screwing a bolt (56) into the threaded portion and rotating the bolt while fixing the axial position of the bolt.

### (Supplementary Note 5)

In the method according to Supplementary note 4, in the region forming step, the bolt inserted through an auxiliary jig (50) attached to the holding plate may be rotated.

### (Supplementary Note 6)

In the method for assembling a battery module according to Supplementary note 3, the pressing portion or the pressure receiving plate superposed on the pressing portion may be provided with an engaging structure (70) including a slit (74) and an engaging groove (76), the region forming step may include an inserting step of inserting a tip portion of a structural member into the slit of the engaging structure, an engaging step of engaging the tip portion with the engaging groove by rotating the structural member, and a moving step of moving the pressing portion by pulling the structural member.

### (Supplementary Note 7)

In the method according to Supplementary note 3, in the region forming step, the pressing portion may be moved by an external magnetic force.

### (Supplementary Note 8)

A holding mechanism of the present disclosure includes a pair of holding plates that are elastically deformable face each other and a plurality of connecting members that connect the pair of holding plates with each other, wherein the holding mechanism is configured to hold a holding object placed between the pair of holding plates by elastic biasing force of the pair of holding plates, each of the plurality of holding plates includes a pressing portion and a plurality of arm portions extending from the pressing portion toward the plurality of connecting members, the plurality of arm portions are connected to the plurality of connecting members, and the pressing portion is configured to be moved in the direction to increase a space between the pair of holding plates by the external force from the outside of the pair of holding plates.

### (Supplementary Note 9)

In the holding mechanism according to Supplementary note 8, a structural member for moving the pressing portion in the direction to increase the space may be attachable to the pressing portion.

### (Supplementary Note 10)

In the holding mechanism according to Supplementary note 9, the pressing portion may be formed with a threaded portion configured to be engaged with the structural member.

### (Supplementary Note 11)

In the holding mechanism described in Supplementary note 9, the pressure receiving plate superposed on the pressing portion may be formed with a threaded portion configured to be engaged with the structural member.

### (Supplementary Note 12)

In the holding mechanism according to Supplementary note 11, the pressing portion may be formed with a through hole (35) through which the bolt, which is the structural member, is inserted.

### (Supplementary Note 13)

In the holding mechanism according to Supplementary note 12, the diameter of the through hole may be approximately the same as the diameter of the threaded portion.

### (Supplementary Note 14)

In the holding mechanism according to Supplementary note 12 or 13, the through hole may be formed at a central portion of the holding plate, and the threaded portion may be formed in a central portion of the pressure receiving plate.

### (Supplementary Note 15)

In the holding mechanism according to Supplementary note 9, the pressing portion or the pressure receiving plate superposed on the pressing portion may be provided with an engaging structure configured to be engaged with the structural member, and the engaging structure may include a slit configured to receive a tip portion of the structural member and an engaging groove configured to be engaged with the tip portion inserted via the slit.

### (Supplementary Note 16)

In the holding mechanism according to Supplementary note 8, a permanent magnet (80) for moving the pressing portion in the direction to increase the space may be fixed to or attachable to the pressing portion.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A method for assembling a battery module,
wherein
the battery module includes:
a cell stack that includes battery cells and heat exchangers stacked on the battery cells, and
a holding mechanism that holds both stacking-direction ends of the cell stack,
the holding mechanism includes
a pair of holding plates that are elastically deformable, and
a plurality of connecting members that connect the pair of holding plates with each other, and
the cell stack is pressed inward in a stacking direction of the cell stack by elastic biasing force of the pair of holding plates, whereby the cell stack is held,
the method comprising:
forming a region where the cell stack is placeable between the pair of holding plates by applying a coercive deformation force that deforms at least one of the pair of holding plates against the elastic biasing force;
arranging the cell stack in the region formed in the forming; and
pressing the cell stack in the stacking direction by the elastic biasing force, by removing the coercive deformation force in a state where the cell stack is placed in the region.

2. The method for assembling the battery module according to claim 1, wherein
each of the pair of holding plates includes a pressing portion and an arm portion that extends from the pressing portion, and
in the forming, the arm portion is deformed by applying the coercive deformation force in a state where an end portion in an extending direction of the arm portion is fixed.

3. The method for assembling the battery module according to claim 2, wherein
in the forming, the pressing portion is moved in a direction opposite to a pressing direction in which the cell stack is pressed in the pressing.

4. The method for assembling the battery module according to claim 3, wherein
at least one of the pressing portion or a pressure receiving plate superposed on the pressing portion is provided with a threaded portion, and
in the forming, the pressing portion is moved by screwing a bolt into the threaded portion and rotating the bolt while fixing an axial position of the bolt.

5. The method for assembling the battery module according to claim 4, wherein
in the forming, the bolt inserted through an auxiliary jig attached to the holding plate is rotated.

6. The method for assembling the battery module according to claim 3, wherein
the pressing portion or a pressure receiving plate superposed on the pressing portion is provided with an engaging structure including a slit and an engaging groove, and
the forming includes
inserting a tip portion of a structural member into the slit of the engaging structure,
engaging the tip portion with the engaging groove by rotating the structural member, and
moving the pressing portion by pulling the structural member.

7. The method for assembling the battery module according to claim 3, wherein
in the forming, the pressing portion is moved by external magnetic force.

8. A holding mechanism comprising:
a pair of holding plates that are elastically deformable and face each other; and
a plurality of connecting members that connect the pair of holding plates with each other,
wherein
the holding mechanism is configured to hold a holding object placed between the pair of holding plates by elastic biasing force of the pair of holding plates,
each of the plurality of holding plates includes
a pressing portion, and
a plurality of arm portions extending from the pressing portion toward the plurality of connecting members, and
the plurality of arm portions are connected to the plurality of connecting members, and
the pressing portion is configured to be moved in a direction to increase a space between the pair of holding plates by external force from outside of the pair of holding plates.

9. The holding mechanism according to claim 8, wherein
a structural member that moves the pressing portion in the direction to increase the space is attachable to the pressing portion.

10. The holding mechanism according to claim 9, wherein
the pressing portion is formed with a threaded portion configured to be engaged with the structural member.

11. The holding mechanism according to claim 9, wherein
a pressure receiving plate superposed on the pressing portion is formed with a threaded portion configured to be engaged with the structural member.

12. The holding mechanism according to claim 11, wherein
the pressing portion is formed with a through hole through which the bolt, which is the structural member, is inserted.

13. The holding mechanism according to claim 12, wherein
a diameter of the through hole is approximately equal to a diameter of the threaded portion.

14. The holding mechanism according to claim 12, wherein
the through hole is formed at a central portion of the holding plate, and
the threaded portion is formed at a central portion of the pressure receiving plate.

15. The holding mechanism according to claim 9, wherein
the pressing portion or a pressure receiving plate superposed on the pressing portion is provided with an engaging structure configured to be engaged with the structural member, and
the engaging structure includes
a slit configured to receive a tip portion of the structural member, and
an engaging groove configured to be engaged with the tip portion inserted through the slit.

16. The holding mechanism according to claim 8, wherein
a permanent magnet for moving the pressing portion in the direction to increase the space is fixed to or attachable to the pressing portion.
